(19) United States
(12) Patent Application Publication
(10) Pub. No.: US 2023/0216938 A1
(43) Pub. Date: Jul. 6, 2023

(54) APPLICATION-BASED DATA TRANSPORT APPARATUS AND METHOD

(71) Applicant: ELECTRONICS AND TELECOMMUNICATIONS RESEARCH INSTITUTE, Daejeon (KR)

(72) Inventors: Ho Sun YOON, Daejeon (KR); Seong MOON, Daejeon (KR); Seung Woo HONG, Daejeon (KR)

(73) Assignee: ELECTRONICS AND TELECOMMUNICATIONS RESEARCH INSTITUTE, Daejeon (KR)

(21) Appl. No.: 17/836,651

(22) Filed: Jun. 9, 2022

(30) Foreign Application Priority Data
Jan. 5, 2022 (KR) 10-2022-0001424

(51) Int. Cl. H04L 69/16; H04L 69/329; G06F 9/54

(52) U.S. Cl. CPC H04L 69/16; H04L 69/329; G06F 9/541

(57) ABSTRACT

Disclosed herein an application-based data transport device and method. The application-based data transport device includes: an application processing unit configured to generate application data for executing an application; a transport service processing unit configured to identify, in the application data, transport service information including at least one of network connection information, network performance information or combination thereof, which are required to execute the application, and to set a network environment based on the transport service information; and a transport processing unit configured to generate and transmit transport protocol data for transmitting the application data, based on the network environment and a transport protocol.

### CROSS REFERENCE TO RELATED APPLICATION

The present application claims priority to a Korean application 10-2022-0001424, filed Jan. 5, 2022, the entire contents of which are incorporated herein for all purposes by this reference.

### BACKGROUND OF THE INVENTION

### Field of the Invention

The present disclosure relates to a technology of controlling a communication channel between application processes and, more particularly, to a method and apparatus for processing a network connection which accommodates a requirement of an application process.

### Description of the Related Art

In order to provide various types of services, an application may have various requirements during data transport. Specifically, as studies on 5G and 6G are actively underway, more and more requirements regarding latency in an application are being presented to provide a real-time service.

Currently, various methods for reducing latency in a network are being studied. In particular, the transmission control protocol (TCP), which is the most widely used transport protocol, is improved, or a new transport protocol like Quick UDP Internet Connections (QUIC) is developed and used. As various transport protocols are present, application developers need to understand characteristics of each protocol and develop an application using an API which each protocol provides. After such an application is developed, when a protocol version is upgraded or the application needs to use a newly developed protocol, an application program should be changed.

### SUMMARY

In order to solve the problem, the Internet Engineering Task Force (IETF) defines an application programming interface between an application and a transport protocol as a socket application programming interface (API) or a transport services API. Using such an API, an application forwards various pieces of information like an endpoint property, a security property, a message property, a connection property, and a property for selecting a protocol to a transport system, and the transport system selects a most suitable transport protocol by using those properties and implements a connection procedure. However, such a transport services API considers only a function of selecting a transport protocol and implementing a connection procedure but does not consider any performance-related requirement. In addition, since such an API defines too many complex properties for selecting and connecting a transport protocol, developers have difficulty using it when actually developing an application. That is, it is necessary to provide an API that not only implements a simple connection but also accommodates performance requirements and is easy to use.

A technical object of the present disclosure is to provide a method and apparatus for setting a connection satisfying performance information required by an application by adding a new API between an application and a transport protocol.

The technical problems solved by the present disclosure are not limited to the above technical problems and other technical problems which are not described herein will become apparent to those skilled in the art from the following description.

According to the present disclosure, there is provided an application-based data transport device, the device comprising: an application processing unit configured to generate application data for executing an application; a transport service processing unit configured to identify, in the application data, transport service information including at least one of network connection information, network performance information or combination thereof, which are required to execute the application, and to set a network environment based on the transport service information; and a transport processing unit configured to generate and transmit transport protocol data for transmitting the application data, based on the network environment and a transport protocol.

According to the embodiment of the present disclosure in the device, the transport service processing unit may include at least one of: a connection & property manager (CPM) processing unit configured to manage network connection information and a network property; a requirement verification manager (RVM) processing unit configured to verify whether or not network connection information and network performance information, which are required to execute the application, are satisfied; a network capability manager (NCM) processing unit configured to set network performance; a message translation manager (MTM) processing unit configured to modify a message; a transport protocol manager (TPM) processing unit configured to select and control a transport protocol; a system capability manager (SCM) processing unit configured to set local system performance; or combination thereof.

According to the embodiment of the present disclosure in the device, the transport service processing unit may be further configured to, from a network policy manager server, check and manage information on the network environment.

According to the embodiment of the present disclosure in the device, the transport service processing unit may be further configured to: check a first latency required for an overall path and a second latency required for a local system; and check the network performance information based on the first latency and the second latency.

According to the embodiment of the present disclosure in the device, the transport service processing unit may be further configured to: check a ratio of the second latency to the first latency; and check the network performance information based on the checked ratio.

According to the embodiment of the present disclosure in the device, the transport service processing unit may be further configured to: check a reference latency required in the transport service information; and check the network performance information by comparing the reference latency and the first and second latencies.

According to the embodiment of the present disclosure in the device, the transport service processing unit may be further configured to: identify a property for the transport protocol; and identify a transport protocol satisfying the identified property.

According to the embodiment of the present disclosure in the device, the transport service processing unit may be further configured to: check a priority order for the plurality of transport protocols in response to presence of a plurality of transport protocols satisfying the identified property; and determine the transport protocol based on the checked priority order.

According to the embodiment of the present disclosure in the device, the property for the transport protocol may include at least one of a reliability property, a security property, a multistreaming property or combination thereof.

According to another embodiment of the present disclosure, there is provided a data transport method, the method comprising: generating application data for executing an application; identifying, in the application data, transport service information including at least one of network connection information, network performance information or combination thereof, which are required to execute the application; setting a network environment based on the transport service information; and generating and transmitting transport protocol data for transmitting the application data, based on the network environment and a transport protocol.

The features briefly summarized above for this disclosure are only exemplary aspects of the detailed description of the disclosure which follow and are not intended to limit the scope of the disclosure.

According to the present disclosure, it is possible to provide a method and apparatus for setting a connection satisfying a network performance requirement like a bandwidth and a latency through a simple APIC call in an application layer.

According to the present disclosure, as an application may be configured to set a network performance requirement both for a local system and for a network, a method and apparatus for enabling more accurate and finer control may be provided.

According to the present disclosure, it is possible to provide a method and apparatus for easily setting a connection in an application layer by using a simple API to set a network environment.

According to the present disclosure, it is possible to provide a method and apparatus for verifying whether or not a performance requirement is continuously satisfied after a connection required by an application is set.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a block diagram illustrating a system to which an application-based data transport device according to an embodiment of the present disclosure is applied.

FIG. 2 is a block diagram illustrating a detailed configuration of a transport service management layer in an application-based data transport device according to an embodiment of the present disclosure.

FIG. 3 is a block diagram illustrating an architecture of an application-based data transport device according to an embodiment of the present disclosure.

FIG. 4A and FIG. 4B are views illustrating a detailed configuration and a parameter of a transport services API in an application-based data transport device according to an embodiment of the present disclosure.

FIG. 4C is a view illustrating a detailed configuration and a parameter of a network policy interface in an application-based data transport device according to an embodiment of the present disclosure.

FIG. 5 is a flowchart illustrating a connection setting operation of an application-based data transport device according to an embodiment of the present disclosure.

FIG. 6 is a flowchart illustrating a connecting operation of an application-based data transport device according to an embodiment of the present disclosure.

FIG. 7 is a flowchart illustrating a message transmission operation of an application-based data transport device according to an embodiment of the present disclosure.

FIG. 8 is a flowchart illustrating a message reception operation of an application-based data transport device according to an embodiment of the present disclosure.

FIG. 9 is a flowchart illustrating a connection closing operation of an application-based data transport device according to an embodiment of the present disclosure.

FIG. 10 is a flowchart illustrating the detailed operations of step S517 of FIG. 5.

FIG. 11 is a flowchart illustrating the detailed operations of step S521 of FIG. 5.

FIG. 12 is a block diagram illustrating a computing system for implementing an application-based data transport method and apparatus according to an embodiment of the present disclosure.

### DETAILED DESCRIPTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, ““at Each of the phrases such as “at least one of A, B or C” and “at least one of A, B, C or combination thereof” may include any one or all possible combinations of the items listed together in the corresponding one of the phrases.

Hereinafter, embodiments of the present disclosure will be described with reference to the accompanying drawings.

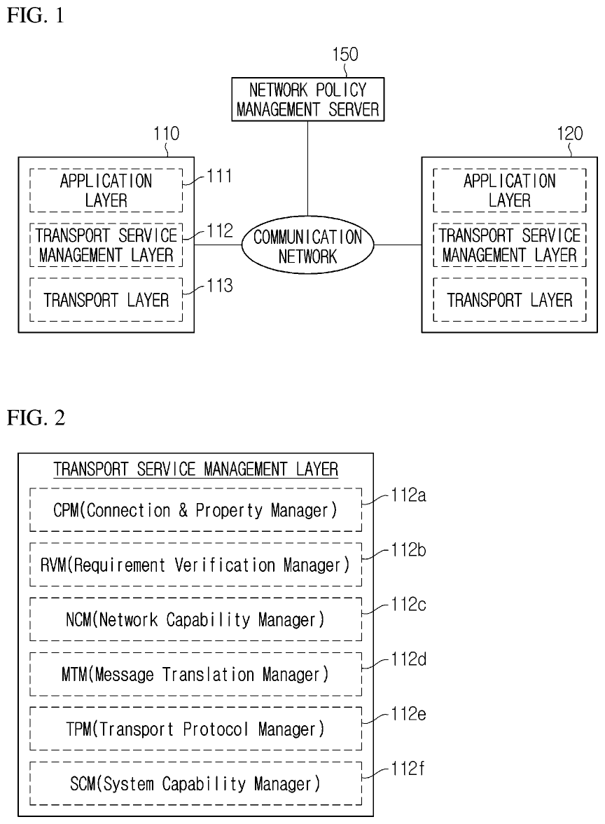

FIG. 1 is a block diagram illustrating a system to which an application-based data transport device according to an embodiment of the present disclosure is applied.

Referring to FIG. 1, a system according to an embodiment of the present disclosure may include application-based data transport devices 110 and 120, and a network policy management server 150. The application-based data transport devices 110 and 120 and the network policy management server 150 may be connected through a communication network.

The application-based data transport devices 110 and 120 may execute an application and verify transport service information including at least one of network connection information and network performance information, which are required during execution of the application.

In addition, when transporting application data, the application-based data transport devices 110 and 120 may provide transport service information, which is requested by an application, and check a local system performance setting, a network performance setting, whether or not a performance requirement is satisfied and the like, by using an API in it. In addition, the application-based data transport devices 110 and 120 may set a local system and a network so as to satisfy a requirement of an application and may perform a function of setting a connection by using a transport protocol.

When the local system and the network are set, information on the network may be requested, and the network policy management server 150 may provide the information on the network to the application-based data transport devices 110 and 120. Accordingly, the application-based data transport devices 110 and 120 may perform an operation of setting the above-described local system and network by using the information on the network. In addition, the network policy management server 150 may constantly update and provide the information on the network, and the application-based data transport devices 110 and 120 may perform the operation of setting the above-described local system and network by reflecting the updated information. This leads to an advantage that, when a version of a transport protocol is upgraded or even when a new type transport protocol is applied, an application can be easily developed.

Furthermore, the application-based data transport devices 110 and 120 may include an application layer 111, a transport service management layer 112, and a transport layer 113.

The application layer 111 may perform an operation of generating application data for executing an application, and, based on a network environment and a transport protocol, the transport layer 113 may perform an operation of generating and transporting transport protocol data for transporting application data. As an example, the transport layer 113 may perform an operation of generating and transporting data of transport protocols such as TCP, UDP and QUIC.

Meanwhile, the transport service management layer 112 may be provided between the application layer 111 and the transport layer 113 and may verify, from the application data, transport service information including at least one of network connection information and network performance information, which are required during execution of the application, as described above. In addition, based on the transport service information, the transport service management layer 112 may perform an operation of setting a network environment to be used in the transport layer 113.

Furthermore, in an embodiment of the present disclosure, an operation of the application layer 111 may be performed by an application processing unit, an operation of the transport service management layer 112 may be processed by a transport service processing unit, and an operation of the transport layer 113 may be performed by a transport processing unit.

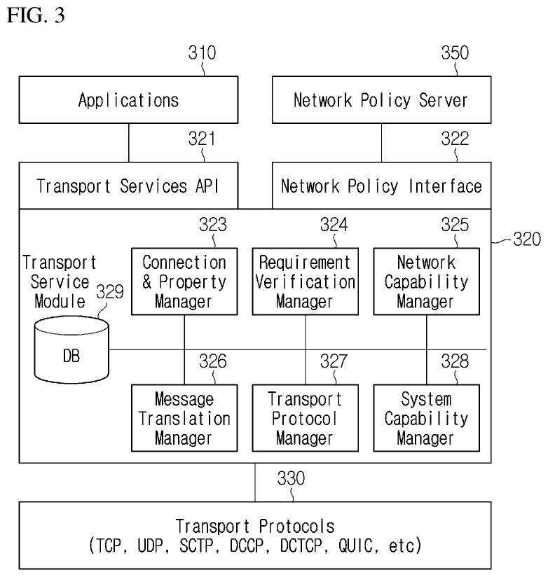

FIG. 2 is a block diagram illustrating a detailed configuration of a transport service management layer in an application-based data transport device according to an embodiment of the present disclosure.

Referring to FIG. 2, a transport service management layer of a device according to an embodiment of the present disclosure may include at least one of a connection & property manager (CPM) 112a, a requirement verification manager (RVM) 112b, a network capability manager (NCM) 112c, a message translation manager (MTM) 112b, a transport protocol manager (TPM) 112e, and a system capability manager (SCM) 112f.

The CPM 112a may manage network connection information and a network property.

The RVM 112b may verify whether or not network connection information and network performance information are satisfied which are required to execute an application.

The NCM 112c may set network performance

The MTM 112d may change a message, and the TPM 112e may select and control a transport protocol.

The SCM 112f may set local system performance.

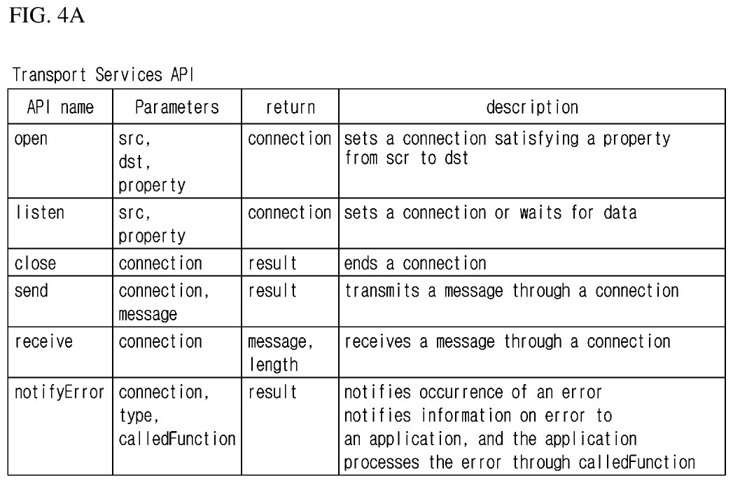

FIG. 3 is a block diagram illustrating an architecture of an application-based data transport device according to an embodiment of the present disclosure.

Referring to FIG. 3, an application-based data transport device 300 may include an application processing unit 310, a transport service processing unit 320, and a transport processing unit 330.

In addition, the transport service processing unit 320 may include a transport services API 321 and a network policy interface 322.

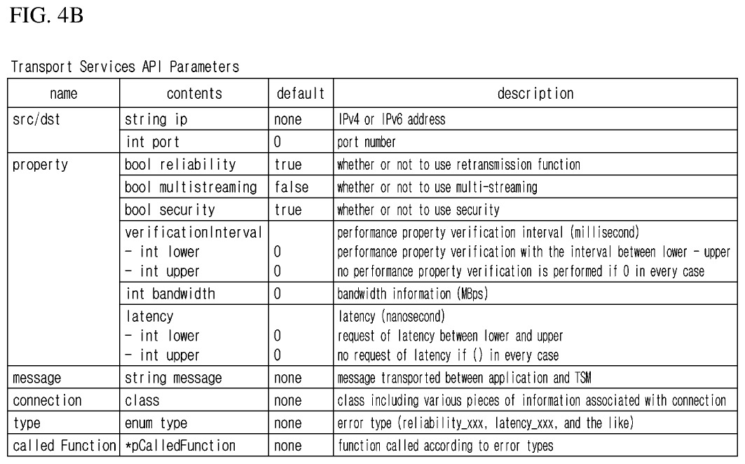

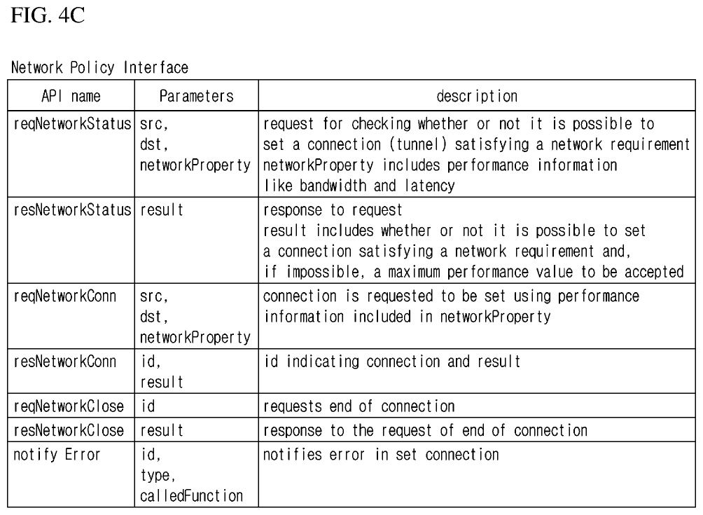

The transport services API 321 may be connected to the application processing unit 310 and may check and provide information required in the application processing unit 310. A detailed configuration of the transport services API 321 and a parameter may be exemplified as in FIG. 4A and FIG. 4B.

In FIG. 4B, verificationInterval sets a verification interval for checking whether or not a performance property required by an application is normally supported. By setting thresholds for a most frequent time interval of performing verification and a least frequent time interval of performing verification, verification may be flexibly performed according to error frequency. For example, when an error occurs frequently, verification of performance needs to be frequently performed, and when an error does not occur frequently, verification of performance needs not be frequently performed. No detailed algorithm is described in the present invention.

In FIG. 4B, bandwidth means a maximum bandwidth for maintaining a latency. For example, when a bandwidth is 100 MB and a latency is 100 ms, a performance requirement is that the latency of 100 ms is ensured until a 100 MB message is transmitted per second. This means that, when a bandwidth of data transported by an application exceeds 100 MB per second, the latency of 100 ms cannot be ensured.

In FIG. 4B, latency is intended to set a latency required to forward data. As a latency request is set as a range, a latency may be flexibly set. For example, when a latency is set to 100 ms˜200 ms, a local system and a network are set to require a latency between 100 ms and 200 ms for data transport. In case a lower value and an upper value are identical, data should arrive at a destination exactly after a corresponding time. In this case, data forwarded from the local system and the network needs to be accurately controlled in order to arrive at the destination in an exact time.

Meanwhile, the network policy interface 322 may be connected to the network policy management server 350 and provide data, which is provided from the network policy management server 350, to a constitutional unit in the transport service processing unit 320.

A detailed configuration of the network policy interface 322 and a parameter may be exemplified as in FIG. 4C.

In FIG. 4C, an interface starting with req is an interface in which a network capability manager (NCM) makes a request to a network policy server (NPS), and an interface starting with res is an interface in which the NPS responds to the NCM. notyfyError is an interface in which an NPS processing unit forwards an error occurring to a set connection to an NCM processing unit. reqNeworkStatus is an interface in which the NCM checks only whether or not the NPS can set a connection satisfying a requirement, and reqNetworConn is an interface in which an actual connection is requested.

The transport service processing unit 320 may include a CPM processing unit 323, a RVM processing unit 324, an NCM processing unit 325, an MTM processing unit 326, a TPM processing unit 327 and an SCM processing unit 328, which perform an operation of the transport service management layer of FIG. 2.

The CPM processing unit 323 receives a requirement associated with connection and performance from the application processing unit 310, performs an overall procedure for setting a connection satisfying the received requirement, and manages relevant connection and performance information through a database.

The RVM processing unit 324 performs a function of checking whether or not a connection set to satisfy a performance requirement demanded by an application actually satisfies the performance requirement.

The NCM processing unit 325 performs a function of setting a network connection that satisfies a performance requirement associated with a network through interworking with an NPS.

The MTM processing unit 326 performs a function of adding and removing metadata to and from a message when transmitting and receiving the message. For example, when a transmission side application 100 forwards a 100-byte message, a reception side application 100 wants to receive a 100-byte message. However, in case TCP is used as a transport protocol, an exactly 100-byte message may not be received at once. In order to solve this problem, the message forwarded by the transmission side application may be modified to include a message length in a transmission side MTM processing unit, and after the reception side MTM processing unit receives the message as long as the message length, the message may be forwarded to an application. As another example, metadata about QoS information may be added to a transported message. Thus, when metadata about QoS information is added to a transported message, devices for forwarding the message may be configured to utilize the QoS information in the metadata. That is, devices, which forward a message, may transport the message by using QoS-related metadata included in the message to make the message satisfy QoS.

The above-described operation may be set differently according to a type of a transport protocol. As an example, when such a protocol as UDP is used, the above-described operation may be skipped.

The TPM processing unit 327 performs a function of selecting and controlling a transport protocol satisfying a connection requirement among transport protocols.

The SCM processing unit 328 performs a function of setting a system so as to satisfy a performance requirement in a local system. As an example, the SCM processing unit 328 may make and distribute an SCM suitable for a local system or a kernel in order to set a queue or a shaper in relation to performance in the local system.

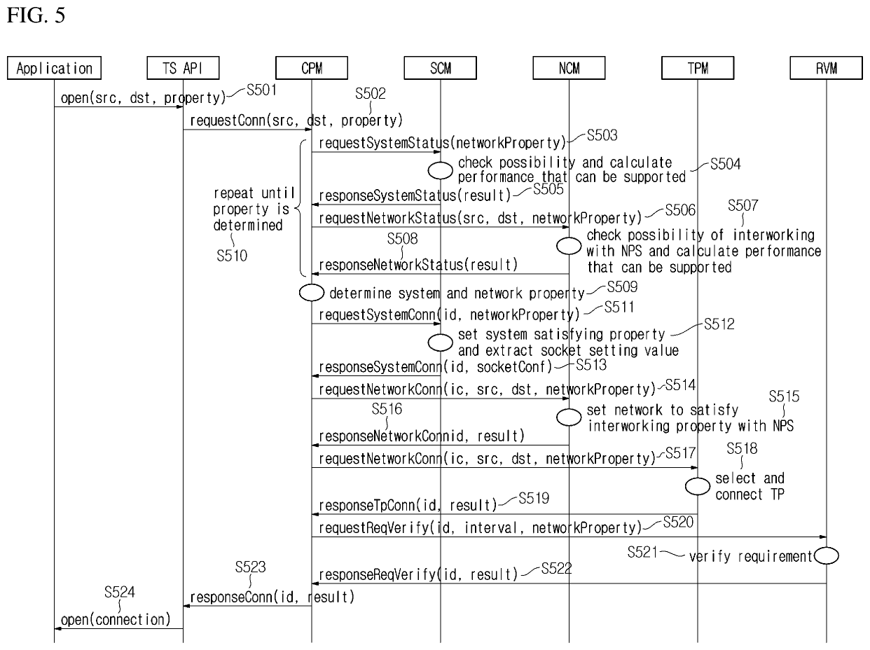

FIG. 5 is a flowchart illustrating a connection setting operation of an application-based data transport device according to an embodiment of the present disclosure.

Referring to FIG. 5, first, an application processing unit makes a connection request to a CPM processing unit through a transport services API (S501, S502). Herein, parameters for using a transport services API have a same value as that of open described in FIG. 4A. The CPM processing unit, which receives a performance requirement from an application, needs to distinguish a requirement associated with performance into performance to be supported in a local system and performance to be supported in a network. For packets which are actually exchanged, the CPM processing unit may calculate a ratio of a latency required in the local system to a latency in an overall path and may use the information. That is, for data transported in each connection, when an average latency for the overall path and an average latency in the local system are stored and the information is used, a ratio of the latency occurring in the local system to the latency required in the overall path may be calculated. For example, when an application requires a bandwidth of 100 MB and a latency of 100 ms, the CPM processing unit estimates whether or not the local system is capable of supporting the bandwidth and predicts a ratio of latency to be required in the local system to that of the overall path. When it is predicted that the local system will support a 100 MB bandwidth and require a 10 ms latency (the local system requires 10% of latency of the overall path), if the network supports a 100 MB bandwidth and a 90 ms latency, the CPM processing unit may determine that the performance requirement of the application can be satisfied. As a device at reception side tries to forward a received packet to the application as fast as possible, latency will not be separately considered.

At steps S503, 504 and 505, the SCM processing unit may check whether or not it is possible to provide a performance requirement to be provided in a local system. In the above-described example where the bandwidth requirement is 100 MB and the latency requirement is 10 ms in the local system, this is an operation of checking whether or not the local system is capable of providing the performance requirement. The SCM processing unit checks whether or not a local system has a queue capable of supporting a 100 MB bandwidth and also checks whether or not it is possible to set a queue and a shaper so as to carry a 100 MB traffic for 10 ms in a local system. When support is impossible, the SCM processing unit may calculate a latency, which is expected to be required in a local system, through a setting of a queue and a shaper and may return the latency.

In addition, a result expected through such an operation may not be correctly predicted according to a state of a local system, and an operation for checking whether or not a prediction is correct may be required. For example, the SCM processing unit may check whether or not a prediction is correct, by performing step S512 or by performing an operation of actually transporting data.

At steps S506, S507 and S508, the NCM processing unit may check whether or not it is possible to provide a performance requirement for a network, through interworking with the NPS processing unit. As an example, whether or not the network is capable of providing a bandwidth of 100 MB and a latency of 90 ms is calculated, and the result is forwarded to the CPM processing unit. In case the requirement is not satisfied, performance information, which can be supported, is calculated and forwarded to the CPM processing unit.

Although, in an embodiment of the present disclosure, the steps S503, S504 and S505 and the steps S506, S507 and S508 are described to proceed successively, the steps S503, S504 and S505 and the steps S506, S507 and S508 may be processed simultaneously.

At steps S509 and S510, the CPM processing unit may perform an operation of determining a performance requirement which a local system and a network should provide. As described above, in case a latency of 10 ms is required to a local system and a latency of 90 ms is required to a network, when a response is received to the effect that the local system cannot provide the requirement of 10 ms latency but can provide a 20 ms latency and the network can provide the requirement of 90 ms latency, the CPM processing unit may query the NCM processing unit whether or not it can provide an 80 ms latency to the network. In case the NCM processing unit sends a positive response, it may be determined that the local system provides a 20 ms latency and the network provides an 80 ms latency. In case both the local system and the network are incapable of supporting, the CPM processing unit may finally determine that support is not possible.

At steps S511, S512 and S513, the SCM processing unit may set a system to satisfy an actual local system performance requirement. An id value forwarded at step S511 is generated in the CPM processing unit and then is used as a value representing connection. At step S512, a local system may be set to actually satisfy a performance requirement, and socket information thus set may be forwarded to the CMP processing unit through step S513. Such socket information may be utilized at a subsequent step of setting a transport protocol.

At steps S514, S515 and S516, the NCM processing unit may mean a procedure for setting a network to satisfy a network performance requirement. At step S514, an id value used at step S511 is used, and src, dst and networkProperty information used at step S506 is used. At step S515, a connection satisfying a performance requirement is set to the NPS processing unit through an interface defined in FIG. 4C, and at step S516, the result may be forwarded.

Furthermore, network devices may forward a message by using metadata associated with QoS in the message. In this case, the result forwarded at step S516 may include information associated with metadata. When a subsequent message is forwarded to a destination, such metadata-related information may be included in the message through MTM and may be configured in various forms according to a method used by network devices.

At steps S517, S518 and S519, the TPM processing unit means a procedure of selecting a transport protocol through connection information and performing an actual connection by controlling the selected protocol. tpProperty forwarded through step S517 includes only connection-related items like reliability, multistreaming and security among properties of FIG. 4B. At step S518, the TPM processing unit may select a protocol by using tpProperty information and perform an actual procedure of connection, and at step S519, the TPM processing unit may forward a corresponding result to the CPM processing unit.

At steps S520, S521 and S522, the RVM processing unit means a procedure for checking whether or not a connection thus set satisfies a performance requirement. networkProperty forwarded through step S520 includes a performance requirement for an overall connection, and interval includes information on a time interval for performing a subsequent verification. At step S521, the RVM processing unit verifies the performance requirement, and at step S522, the RVM processing unit forwards a corresponding result to the CPM processing unit. Subsequently, verification of the performance requirement is continuously performed at a time interval defined in interval.

Next, at steps S523 and S524, a setting result of overall connection may be forwarded to the application.

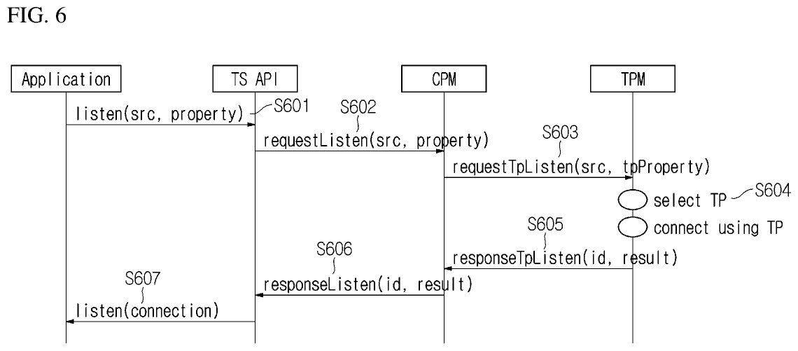

FIG. 6 is a flowchart illustrating a connecting operation of an application-based data transport device according to an embodiment of the present disclosure.

Referring to FIG. 6, first, an application processing unit may forward a connection request to a CPM processing unit by using a transport services API (S501, S502). Herein, src means information for waiting for connection or message reception, and property means property information. As there is no setting related to performance at reception side, property information includes connection information like reliability, multistreaming and security. At step S503, the CPM processing unit may forward information for performing a listen procedure to a TPM processing unit, and the TPM processing unit may select a transport protocol and perform an operation of trying a connection using the transport protocol (S604). Next, the TPM processing unit may provide the selected protocol to the application processing unit through the CPM processing unit and a transport services API (S605, S606, S607). For example, in case the selected protocol is a TCP, it may stand by for a connection, and in case the selected protocol is a UDP, it may stand by for message reception.

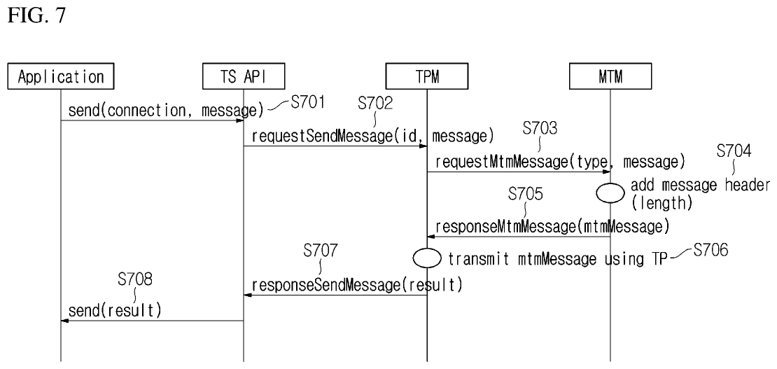

FIG. 7 is a flowchart illustrating a message transmission operation of an application-based data transport device according to an embodiment of the present disclosure.

Referring to FIG. 7, first, an application processing unit forwards a message, which is to be transmitted to a destination, to a TPM processing unit through a transport services API (S701, S702). The TPM processing unit may forward the message to an MTM processing unit (S703), and the MTM processing unit may add message length information through step S704. Herein, the message length information may be added in a header form.

At step S705, the MTM processing unit may forward a response message with the added message length information to the TPM processing unit. The TPM processing unit may provide the message (response message with added message length information) to the application processing unit through the transport services API (S706, S707, S708). In case there are metadata associated with QoS, relevant information may be added at an MTM, and network devices may forward a packet satisfying a QoS requirement defined by the metadata.

Although, in an embodiment of the present disclosure, a response message with added message length information is generated and transmitted through the MTM processing unit, the present disclosure is not limited thereto. As another example, when no change of message is needed according to a characteristic of a transport protocol, the steps S703, S704 and S705 may be omitted.

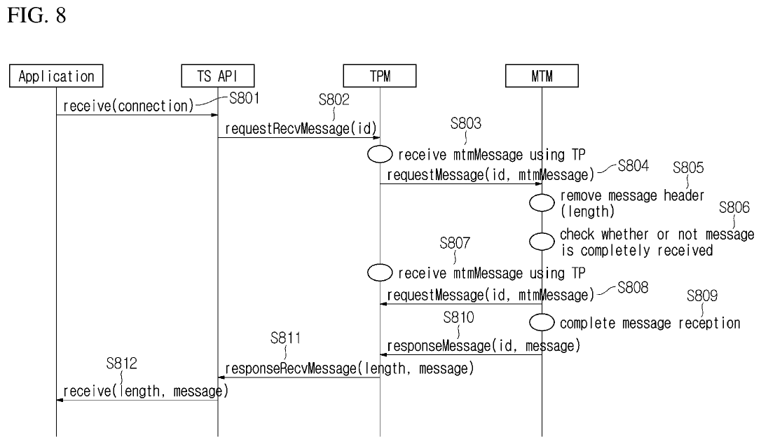

FIG. 8 is a flowchart illustrating a message reception operation of an application-based data transport device according to an embodiment of the present disclosure.

Referring to FIG. 8, first, an application processing unit may request a TPM processing unit to receive a message through a transport services API (S801, S802). Next, the TPM processing unit receives the message (S803). Herein, the received message may be a message including a message length, and the TPM processing unit forwards the received message to an MTM processing unit (S804). The MTM processing unit removes a message header, confirms message length information and checks whether or not every message is received (S805, S806). For example, the MTM processing unit stands by until an additional message is received, when the received message is shorter than the message length. The TPM processing unit may constantly receive messages (S807) and repeatedly forward a received message to the MTM processing unit (S808).

In response, the MTM processing unit may check whether or not every message is received, and when completing reception (S809), the MTM processing unit may forward every message to an application processing unit through the TPM processing unit and the transport services API. The message thus forwarded may exclude a message header. In case no change of message is needed according to a characteristic of a transport protocol, the steps S803 to S810 may be omitted.

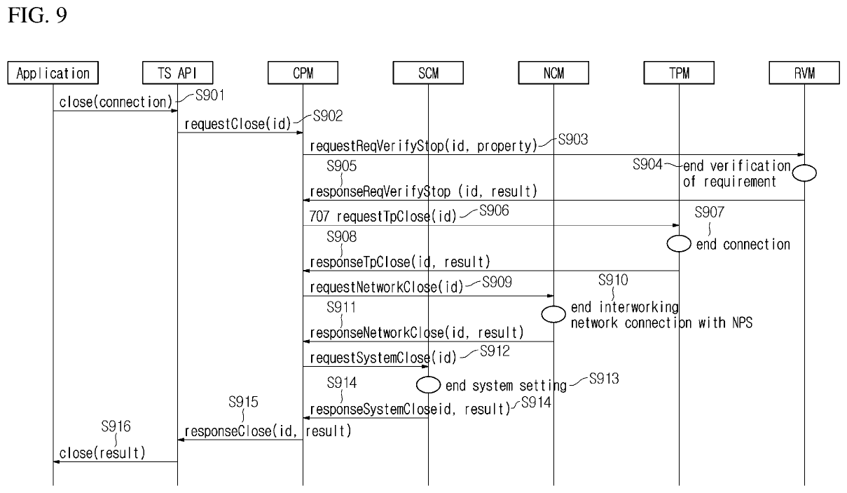

FIG. 9 is a flowchart illustrating a connection closing operation of an application-based data transport device according to an embodiment of the present disclosure.

Referring to FIG. 9, first, an application processing unit may request a CPM processing unit to end connection through a transport services API (S901, S902). The CPM processing unit may periodically perform verification of a performance requirement through a RVM processing unit, and when receiving the request to end the connection, the CPM processing unit may request the RVM processing unit to end the verification of the performance requirement (S903). In response, the RVM processing unit may end the verification of the performance requirement and send a response to the CPM processing unit (S904, S905).

Next, the CPM processing unit may request a TCPM processing unit to end the connection of a transport protocol and perform an operation of returning a corresponding result (S906, S907, S908).

In addition, the CPM processing unit may remove every performance information set in a network through interworking with the NPS processing unit and may perform an operation of returning a corresponding result (S909, S910, S911).

In addition, the CPM processing unit removes every performance information set in a local system during a connection setting procedure and performs an operation of returning a corresponding result (S912, S913, S914). Next, the CPM processing unit may forward a result of end of connection to the application processing unit through the transport services API.

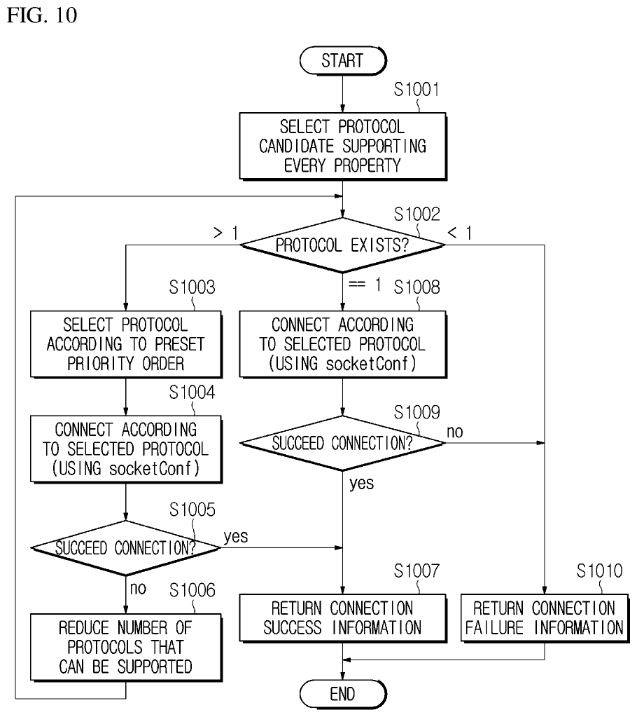

FIG. 10 is a flowchart illustrating the detailed operations of step S517 of FIG. 5.

Referring to FIG. 10, first, at step S1001, an application processing unit may perform an operation of selecting a transport protocol which satisfies every requirement requested through tpProperty included in step S516. A property, which can be provided by each protocol, may be defined in advance. For example, TCP and TLS protocols may provide reliability and security properties, and QUIC protocol may provide properties of reliability, security, multistreaming and the like. Next, at step S1002, the application processing unit may check a number of protocols selected as candidates. When there is no protocol selected as a candidate, the application processing unit may proceed to step S1010, when there is one protocol selected as a candidate, it may proceed to step S1008, and when there is a plurality of protocols selected as candidates, it may proceed to step S1003.

At step S1003, the application processing unit may select one protocol among multiple candidate protocols according to a predetermined priority order. Next, the application processing unit may make a connection by using the selected protocol (S1004). Herein, the application processing unit may make the connection by using the socket setting information socketConf obtained at step S512 described above.

At step S1003, the application processing unit may check, by using the selected protocol, whether or not the connection is successful, and when the connection is successful, the application processing unit may proceed to step S1007. When the connection using the selected protocol fails, the application processing unit may reduce the number of protocols capable of support by 1 and then make a connection to a next candidate protocol by implementing step S1002 again.

Meanwhile, the application processing unit may return connection success information at step S1007 and return failure information at step S1010.

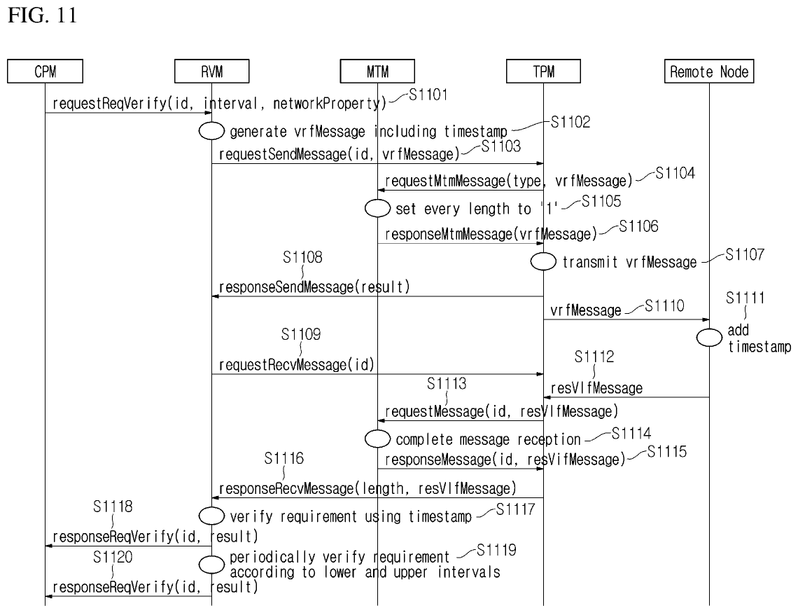

FIG. 11 is a flowchart illustrating the detailed operations of step S521 of FIG. 5.

At step S1101, the application processing unit may request authentication to the RVM processing unit, and the RVM processing unit may perform an operation of generating a message for verification including timestamp information (S1102).

At step S1103, the RVM processing unit forwards the generated message for verification to the TPM processing unit. At step S1104, the TPM processing unit may forward the message for verification to the MTM processing unit. Herein, by using a type parameter, the TPM processing unit may notify that the message is a message for verifying performance.

At step 1105, the MTM processing unit may add a header for indicating a length to the received message. Herein, when confirming that the message is a message for verifying performance through the type parameter, it may set every length to 1 and thus enable the message to be recognized as a message for verifying performance at reception side. The message for verifying performance may be always configured with a predetermined length since it includes a message length, a transmission side timestamp, and a reception side timestamp.

At step S1106, the MTM processing unit may transmit the message configured at step 1105 to the TPM processing unit. Next, the TPM processing unit may forward the message for verification to a destination (S1107) and forward a message transmission result to the RVM processing unit (S1108). In addition, after receiving the message transmission result, the RVM processing unit may stand by for receiving a response message (S1109).

At step S1110, the TPM processing unit may forward the message for verification to a destination node through a network and then, at step 1111, may add a timestamp to the received message.

In addition, at step S1112, the TPM processing unit may forward the message through the network, and, at steps S1113, S1114 and S1115, the MTM processing unit may receive a response message for verification with the message length being removed. Herein, since every received message has a length set to 1, the MTM processing unit may confirm that the response message is a message for verification.

At step S1116, the TPM processing unit may forward the received message for verification to the RVM processing unit. In addition, at step S1117, the RVM processing unit may measure a latency by using timestamp information included in the received response message for verification. In case the transmission side and the reception side have completed time-synchronization, both a latency from the transmission side to the reception side and a latency from the reception side to the transmission side may be calculated. On the other hand, the transmission side and the reception side have not completed time-synchronization, RTT may be calculated. For accurate calculation, the transmission side and the reception side need to be completely time-synchronized.

Next, at step S1118, the RVM processing unit may forward a performance verification result to the CPM processing unit. In addition, at step S1119, the RVM processing unit may periodically measure a latency by using lower and upper interval values and forward a result to the CPM processing unit (S1120).

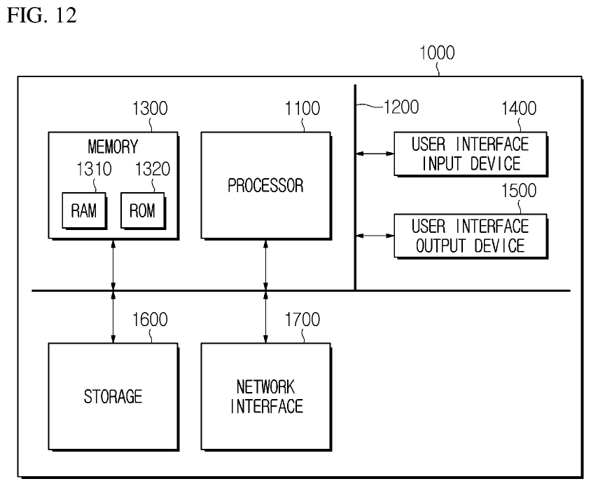

FIG. 12 is a block diagram illustrating a computing system for implementing an application-based data transport method and apparatus according to an embodiment of the present disclosure.

Referring to FIG. 12, a computing system 1000 may include at least one processor 1100, a memory 1300, a user interface input device 1400, a user interface output device 1500, a storage 1600, and a network interface 1700, which are connected through a bus 1200.

The processor 1100 may be a semi-conductor device executing the processing of commands stored in a central processing unit (CPU) or the memory 1300 and/or the storage 1600. The memory 1300 and the storage 1600 may include various types of volatile or non-volatile storage media. For example, the memory 1300 may include a read only memory (ROM) and a random access memory (RAM).

Accordingly, steps of a method or an algorithm described in relation to embodiments of the present disclosure may be directly implemented by hardware, which is executed by the processor 1100, a software module, or a combination of these two. A software module may reside in a storage medium (that is, the memory 1300 and/or the storage 1600) like RAM, flash memory, ROM, EPROM, EEPROM, register, hard disk, removable disk, and CD-ROM. An exemplary storage medium is coupled with the processor 1100, and the processor 1100 may read information from a storage medium and may write information into a storage medium. In another method, a storage medium may be integrated with the processor 1100. A processor and a storage medium may reside in an application-specific integrated circuit (ASIC). An ASIC may reside in a user terminal In another method, a processor and a storage medium may reside in a user terminal as individual components.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. An application-based data transport device comprising:
an application processing unit configured to generate application data for executing an application;
a transport service processing unit configured to identify, in the application data, transport service information including at least one of network connection information, network performance information or combination thereof, which are required to execute the application, and to set a network environment based on the transport service information; and
a transport processing unit configured to generate and transmit transport protocol data for transmitting the application data, based on the network environment and a transport protocol.

2. The application-based data transport device of claim 1, wherein the transport service processing unit comprises at least one of:
a connection & property manager (CPM) processing unit configured to manage network connection information and a network property;
a requirement verification manager (RVM) processing unit configured to verify whether or not network connection information and network performance information, which are required to execute the application, are satisfied;
a network capability manager (NCM) processing unit configured to set network performance;
a message translation manager (MTM) processing unit configured to modify a message;
a transport protocol manager (TPM) processing unit configured to select and control a transport protocol;
a system capability manager (SCM) processing unit configured to set local system performance; or combination thereof.

3. The application-based data transport device of claim 1, wherein the transport service processing unit is further configured to, from a network policy manager server, check and manage information on the network environment.

4. The application-based data transport device of claim 1, wherein the transport service processing unit is further configured to:
check a first latency required for an overall path and a second latency required for a local system; and
check the network performance information based on the first latency and the second latency.

5. The application-based data transport device of claim 4, wherein the transport service processing unit is further configured to:
check a ratio of the second latency to the first latency; and
check the network performance information based on the checked ratio.

6. The application-based data transport device of claim 4, wherein the transport service processing unit is further configured to:
check a reference latency required in the transport service information; and
check the network performance information by comparing the reference latency and the first and second latencies.

7. The application-based data transport device of claim 1, wherein the transport service processing unit is further configured to:
identify a property for the transport protocol; and
identify a transport protocol satisfying the identified property.

8. The application-based data transport device of claim 7, wherein the transport service processing unit is further configured to:
check a priority order for the plurality of transport protocols in response to presence of a plurality of transport protocols satisfying the identified property; and
determine the transport protocol based on the checked priority order.

9. The application-based data transport device of claim 7, wherein the property for the transport protocol includes at least one of a reliability property, a security property, a multistreaming property or combination thereof.

10. A data transport method comprising:
generating application data for executing an application;
identifying, in the application data, transport service information including at least one of network connection information, network performance information or combination thereof, which are required to execute the application;
setting a network environment based on the transport service information; and
generating and transmitting transport protocol data for transmitting the application data, based on the network environment and a transport protocol.
